(19) United States
(12) Patent Application Publication
(10) Pub. No.: US 2010/0031850 A1
(43) Pub. Date: Feb. 11, 2010

(54) TACKIFYING SOLUTION

(76) Inventor: John Neufeld, Winnipeg (CA)

Correspondence Address: ADE & COMPANY INC., 2157 Henderson Highway, WINNIPEG, MB, R2G1P9, CA

(21) Appl. No.: 12/280,236

(22) PCT Filed: Feb. 21, 2007
(86) PCT No.: PCT/CA07/00251

§ 371 Date: Apr. 2, 2009

Related U.S. Application Data
(60) Provisional application No. 60/775,351, filed on Feb. 22, 2006.

(30) Foreign Application Priority Data
May 26, 2006 (CA) 2,549,690

(51) Int. Cl. C08L 93/04

(52) U.S. Cl. 106/237; 106/236

(57) ABSTRACT

A tackifier solution comprising a pale, highly hydrogenated non-toxic rosin and a suitable, non-toxic solvent is described for use in improving gripping contact between a user and a grip-able object. The grip-able object is preferably a sports object or sporting object and application of the solution to the hand(s) or glove(s) of the user or to the gripping surface of the object results in improved gripping control and power transfer compared to an untreated hand, glove or surface.

### PRIOR APPLICATION INFORMATION

This application claims the benefit of U.S. Provisional Application 60/775,351, filed Feb. 22, 2006 and Canadian Patent Application 2,549,690, filed May 26, 2006.

### BACKGROUND OF THE INVENTION

In the field of athletics and in other fields of endeavour, it is often desirable to have a temporary and solid grip, between, for example, the batting gloves of a baseball batter and the baseball bat, or between the hands and/or glove(s) of a golfer and the handle of a golf club, or between the hand of a tennis player and the grip of a tennis racket, to maximize power transfer between the individual's hand and the bat, club or racket, as the case may be, to maximize the user's control and to minimize the likelihood that the bat, club or racket will twist upon contact with the ball.

Tackifiers have historically been used in athletics and other fields of endeavour. For example, baseball players have historically used pine tar to increase the batter's grip on the baseball bat, the pine tar being applied to the bat just prior to use, thereby increasing the batter's grip on the bat, and thereby improving the batter's power transfer to the bat, while minimizing the likelihood that the bat will twist or roll on impact with the ball, and additionally minimizing the effort expended by the batter in the gripping of the bat, and thereby permitting the batter to maximize the energy directed toward hitting the ball. Similarly, in the context of the Armed Forces and police services, members of the Armed Forces and police services may utilize a rosin to improve the grip between the member's hand (or glove) and rifle or other weapon, particularly in hot and humid conditions.

Previously known tackifiers have had significant shortcomings. For example, in the case of pine tar, when used as a tackifier, some of the pine tar may be transferred to the user's hand or glove, resulting in the user's hand or glove remaining sticky even after the user has released the bat or other device. In these circumstances, after using pine tar as a tackifier, not only will the user's hands or gloves require cleaning to remove the pine tar (typically using a solvent for this purpose), but additionally, the bat or other device, after being released from the user's hands, will remain sticky, and will collect dirt or other debris on the bat's (or other device's) surface until suitably cleaned. Additionally, pine tar may stain the user's hands, clothing and other articles with which it comes into contact, thereby limiting the unimpeded use of the user's hands, or damaging or ruining the clothing and other articles with which it may come into contact. Additionally, pine tar has characteristics which may irritate the skin.

There is therefore a need for a tackifier which overcomes these shortcomings, and which provides the user with temporary, but effective tackifying qualities, which is activatable and de-activatable by the user when desired, and which is substantially clear and colorless, water/perspiration proof, non-irritating and non-toxic when applied.

### SUMMARY OF THE INVENTION

According to a first aspect of the invention, there is provided a tackifying composition comprising a heat and pressure activated resin dissolved in an evaporating solvent. The tackifying composition may comprise 5-33% resin and 67-95% solvent (or 5-34% resin and 66-95% solvent). The resin may be Foral AX™ or Foral DX™.

According to a second aspect of the invention, there is provided a tackifying composition consisting essentially of a heat and pressure activated resin dissolved in an evaporating solvent.

As will be apparent to one skilled in the art, the phrase ‘consisting essentially of’ refers to the fact that additional components, for example, scenting agents, anti-oxidants and the like may be added. That is, in some embodiments, the tackifying composition consists essentially of the resin and the solvent, although additional chemicals, such as for example but by no means limited to scenting agents, anti-oxidants, preservatives and the like may be added.

According to a third aspect of the invention, there is provided a method of improving or enhancing gripping contact of a surface comprising:

Applying an effective amount of a tackifying composition comprising a heat and pressure activated resin dissolved in an evaporating solvent to said surface.

As will be appreciated, the surface may be the object to be gripped, for example, a grippable object or grippable sporting equipment, or the surface may be the gripping surface, for example, a hand, glove or the like.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

The present invention provides a tackifier which may be used to improve or enhance a user's grip on a surface, for example, a grippable surface, for example, sporting gear such as baseball bats, cricket bats, golf clubs, tennis rackets, hockey and lacrosse sticks, sporting and other gear used in baseball, softball, fastball, football, golf, tennis, squash, racquetball, badminton, table tennis, cricket, polo, bowling, gymnastics, rings, pommel horse, pole vault, javelin, weightlifting, wheelchair sports, rugby, basketball, fishing, ice hockey, croquet, lacrosse, field hockey, snowmobiling, majorette, drumming, shuffleboard, rock climbing, stunt performing, curling, soccer, bull riding, cycling, skeet shooting, rhythmic gymnastics, motocross, car racing, skiing, archery, canoeing, kayaking, fencing, equestrian, rowing and bmx racing and other sporting gear, and other articles where improved or enhanced grip is desired, including, for example, carpentry, hand construction, power and manual tools, rifles and other weapons, law enforcement equipment such as batons and flashlights, and on any other device or object where it is desirable for the user to have improved or enhanced grip. For the purposes of the description of the embodiments of the invention provided herein, the example of a baseball bat handle will be provided, it being understood that the baseball bat handle is being referenced hereinafter as representative of all articles for which it may be desirable that the user have improved or enhanced grip.

Specifically, the composition comprises a mixture of a resin or rosin and a suitable solvent.

Preferably, the rosin is a non-toxic rosin that is light in color, that is, has a low Gardner color. It is noted that most rosins that are alcohol-soluble have a high Gardner color, for example, 5-9, meaning that they typically have a very yellow color.

The rosin or resin is preferably a thermoplastic, acidic resin, for example, a resin prepared by hydrogenating wood rosin. Specifically, it is preferred that the resin or rosin has a high acid number, for example, an acid number of at least 150. It is further noted that hydrogenation of resins improves the stability of the resin and increases resistance to oxidation. ‘Hydrogenated resin’ refers to the fact that the ethylenic unsaturation of the resin acids is partially or substantially completely hydrogenated. Preferably, the resin is fully hydrogenated.

Accordingly, in some embodiments of the invention, the resin is a non-toxic resin having an acid number of at least 150 that is substantially fully hydrogenated and has a low Gardner number, for example, a Gardner number of 14 or more preferably a Gardner number of 1-3 or 1-2. Yet more preferably, the resin is soluble in a non-toxic, benign solvent.

As will be appreciated by one of skill in the art, a suitable resin need not necessarily have all of the characteristics listed above and may still be suitable for use in the invention. However, in preferred embodiments, the resin is a non-toxic, acidic, highly hydrogenated resin having a low Gardner number. Such resins include FORAL AX™ and FORAL DX™, which are manufactured by Pinova, a division of Hercules and/or Eastman Chemicals.

It is of note that FORAL DX is a highly hydrogenated rosin that has a pale to light amber color. FORAL DX has a refractive index of 1.4970 at 100° C., an acid number of 158 and a softening point of 70° C. As will be appreciated by one of skill in the art, any rosin having substantially similar properties as FORAL DX may be considered to be functionally equivalent to FORAL DX within the invention.

FORAL AX is also a highly hydrogenated rosin that has a pale to light amber color, a softening temperature of 75° C., a refractive index of 1.4960 at 100° C. and an abietic acid value of 0.15% (uv) and typically has an acid number of at least about 150. As will be appreciated by one of skill in the art, any rosin having substantially similar properties as FORAL AX may be considered to be functionally equivalent to FORAL AX within the invention.

Both FORAL AX and FORAL DX have negligible solubility in water but are soluble in, for example but by no means limited to, alcohols, esters, ketones, hydrocarbons, chlorinated solvents and mineral oils. It is of note that other suitable solvents will be well known, to one of skill in the art.

As discussed herein, the tackifier composition is arranged for use in situations where the composition may come in contact with skin. Accordingly, as discussed herein, the components of the composition are preferably non-irritants and/or non-toxic or are present in amounts that are non-irritating and/or non-toxic to most users.

Accordingly, in a preferred embodiment, the solvent is a lower alcohol. The lower alcohol is an alcohol of 1-4 carbon atoms, for example, methanol, butanol, isopropanol or ethanol. Given that the composition may be applied directly to the skin, non-toxic and non-irritant lower alcohols are preferred. Accordingly, in a preferred embodiment, the solvents are ethanol or isopropanol. In a yet further preferred embodiment, the solvent is isopropanol.

As is known to those skilled in the chemical arts, rosins typically have greater solubility in ethanol than isopropanol. However, it has been found that FORAL AX and FORAL DX have greater solubility in isopropanol compared to ethanol. Specifically, saturated solutions of these rosins in isopropanol have an actual non-voluble content of approximately 35-40% but only 30-35% in ethanol.

As will be known to one skilled in the chemical arts, there are numerous means known for increasing the solubility of a specific compound in a particular solvent, for example, by heating or by the addition of a co-solvent. It is of note that such suitable co-solvents will be well known by those skilled in the chemical arts, particularly to those familiar with the chemistry of rosins.

In a preferred embodiment, the composition is non-staining, non-irritating, non-toxic, repels dust and debris and is heat and/or pressure-activated. Yet further, the rosin is preferably a pale rosin, for example, a rosin having a low Gardner number, for example, less than 3.

In a preferred embodiment, the composition comprises 5%-40% rosin, for example, FORAL AX or FORAL DX and 60%-95% lower alcohol ((w/w) or (v/v)), for example, isopropanol. More preferably, the composition may comprise 7%-40% rosin and 60%-93% lower alcohol. More preferably, the composition may comprise 7%-35% rosin and 65%-93% lower alcohol. More preferably, the composition may comprise 5%-35% rosin and 65%-95% lower alcohol. Examples of specific formulations are provided in the examples and in Tables 1 and 2.

In some embodiments, the composition further comprises an anti-oxidant. The anti-oxidant may be present at 0.1%-0.3% (v/v) or 0.1%-0.3% (w/w). The anti-oxidant may be any suitable anti-oxidant known in the art, suitable for skin application, for example, but by no means limited to butylated hydroxytoluene and Irganox 1010. It is noted that antioxidants that are functional and stable in alcohols are well known in the art and accordingly other suitable antioxidants will be readily apparent to one skilled in the art. As discussed above, the rosin is highly hydrogenated and accordingly is resistant to oxidation and as such, an antioxidant may not be essential in all embodiments.

In some embodiments, the composition includes a scenting agent. It is of note that scenting agents suitable for application on the skin that are functional and stable in suitable solvents, for example, lower alcohols, are well known in the art. Accordingly, the selection and percentage of scenting agent used in the composition may vary considerably and will depend on consumer preference.

In a preferred embodiment, the composition is arranged for spray-on application. Specifically, the composition may be in a liquid form within a spray-pump bottle for easy application to the desired gripping surface. In other embodiments, the composition may be sprayed onto an applicator and then applied to the gripping surface. In yet other embodiments, the composition may be included in a solid formulation, as discussed herein.

For use, the composition is applied as a spray or otherwise onto the desired gripping surface. As will be appreciated by one of skill in the art, the gripping surface may be, for example, a glove, bat, hand or grip. As discussed herein, the composition acts as a grip enhancer and is preferably heat and pressure activated, as discussed herein.

In another embodiment of the invention, there is provided a method of improving grip on a grip-able surface comprising:

providing a tackifier solution comprising a pale, highly hydrogenated, non-toxic rosin in a lower alcohol solvent;

applying an effective amount of the tackifier solution onto a non-skin grip-able surface; and

having a user grasp the grip-able surface, wherein the grip of the user on the grip-able surface is improved compared to a substantially similar, un-treated grip-able surface.

In another embodiment of the invention, there is provided a method of improving grip on a grip-able surface comprising:

providing a tackifier solution comprising a pale, highly hydrogenated, non-toxic rosin in a lower alcohol solvent;

applying an effective amount of the tackifier solution onto a non-skin grip-able surface of an object or to at least one hand of a user; and

having the user grasp the grip-able surface, wherein the grip of the user on the grip-able surface is improved compared to a substantially similar, un-treated grip-able surface.

In another embodiment of the invention, there is provided a method of maximizing power transfer from a user to a grip-able surface of an object comprising:

providing a tackifier solution comprising a pale, highly hydrogenated, non-toxic rosin in a lower alcohol solvent;

applying an effective amount of the tackifier solution onto a non-skin grip-able surface of an object; and

having a user grasp the grip-able surface, wherein the power transfer from the user to the object is improved compared to a substantially similar, un-treated object.

In another embodiment of the invention, there is provided a method of maximizing power transfer from a user to a grip-able surface of an object comprising:

providing a tackifier solution comprising a pale, highly hydrogenated, non-toxic rosin in a lower alcohol solvent;

applying an effective amount of the tackifier solution onto a non-skin grip-able surface of an object or to at least one hand of a user; and

having the user grasp the grip-able surface, wherein the power transfer from the user to the object is improved compared to a substantially similar, un-treated object. It is noted that there are a variety of means for determining and measuring power transfer known in the art. It is further noted that the comparison to the un-treated object does not necessarily need to be repeated each time.

In some embodiments, the object is preferably a sporting object or sports equipment object, for example, a bat, racquet, baton or other such object as defined herein. It is to be understood that the user intends to grip or desires to grip or establish gripping contact with the object and is desirous of obtaining improved gripping control specific to the intended use of the object compared to an untreated object or untreated gripping glove(s) or hand(s).

As will be appreciated by one of skill in the art, the use of the tackifier composition and the object to be gripped are in some embodiments non-medical and/or non-therapeutic and/or non-medicinal in nature.

As will be apparent to one of skill in the art, as used herein, ‘applying’ has many forms. For example, the tackifier composition may be applied as a spray, for example, as an aerosol spray or as a pump spray, or the tackifier composition may be applied to an applicator, for example, a cloth or other suitable device, and then the applicator may be used on the gripping surface, or the tackifier composition may be in a substantially solid form as discussed herein and may be applied as a solid to the gripping surface.

In some embodiments, the tackifier composition is arranged to be administered to the gripping surface or grip-able surface (which are used interchangeably herein) in a spray format, for example, as an aerosol spray or as a pump spray. In a preferred embodiment, the tackifier composition is administered from a pump spray and each pump delivers approximately 50 μl to 500 μl of the tackifier composition or tackifier solution onto the gripping surface. In some embodiments, each pump may deliver approximately 50 μl to 250 μl or approximately 50 μl to 200 μl.

As will be appreciated by one of skill in the art and as discussed below, the wide range of rosin concentrations enabled within the invention for the tackifier solution provides users with a wide selection for specific uses and preferences. For example, one user may find that a single pump spray application of a 35% solution provides the result desired by that user whereas a different user may find that multiple sprays of a 10% solution provides the desired result.

In general, the method for preparing the tackifier solution comprises mixing X % pale, highly hydrogenated, non-toxic rosin with Y % benign, non-toxic solvent, the sum of X and Y being approximately 100.

As discussed above, the tackifier solution comprises or consists essentially of 5-40% or 5-38% or 5-35% pale, highly hydrogenated, non-toxic rosin and 60-95% or 62-95% or 65-95% benign, non-toxic solvent. As discussed above, in some embodiments, the solution may include additional components, for example, anti-oxidants, scenting agents, co-solvents and the like. Accordingly, the sum of rosin and solvent may not necessarily sum to 100% in all embodiments, but the tackifier solution may be considered to still ‘consist essentially of’ rosin and solvent.

In one embodiment, the tackifier solution of the present invention is a solution of a substantially clear and colorless, water/perspiration proof, non-irritating and non-toxic thermoplastic, acidic hydrogenated wood and/or gum resin (or a combination thereof) which is heat and pressure activated (as that term is described below), and is preferably the resin FORAL AX™ or alternatively the resin FORAL DX™ (which resins are presently being manufactured and sold by Pinova, a division of Hercules and/or Eastman Chemicals) which has been dissolved in a suitable solvent, such as a lower alcohol (that is, an alcohol having 1-4 carbon atoms), and preferably isopropanol or propanol-2 or isopropyl alcohol. The Hercules company refers to FORAL AX as follows: “FORAL AX Fully Hydrogenated Rosin is a thermoplastic, acidic resin produced by hydrogenating rosin to an exceptionally high degree”. For the purposes of the description herein, this product is referred to as a resin.

In the context of the description of the invention provided herein, “heat and pressure activated” means that the tackifier, once applied and adhering to a baseball bat handle or other object, in the absence of both the heat and pressure such as would be provided by the user in gripping the baseball bat handle or other object, provides no (or at most, a negligible) exposed sticky surface (and in this un-activated or de-activated state, will not bind or attach to dirt or other debris), and which, on the application of both heat and pressure such as would be provided by the user in gripping the baseball bat handle or other object, provides a maximum of tackifying characteristics, to the surface upon which the tackifier has been applied.

It is understood that workers skilled in the art will know of alternative substantially clear and colorless, water/perspiration proof, non-irritating and non-toxic thermoplastic, acidic hydrogenated wood and/or gum resins (or combinations thereof) which are heat and pressure activated which may alternatively be utilized within the context of the present invention, and will also know of various alternative non-toxic, non-irritant and highly evaporative solvents which may be utilized within the context of the solution of the present invention.

In a preferred embodiment, the tackifier solution of the present invention is in a liquid form at room temperature, and through the temperature ranges of −26° C. through 40° C., and in an alternative embodiment, may be liquid through a different temperature range. In a preferred embodiment, the tackifier may be sprayed (using, for example, an aerosol with a suitable propellant or non-aerosol sprayer), brushed, sponged or otherwise applied to the surface of the handle of a baseball bat or other article, whereupon the isopropyl alcohol (or other suitable solvent) quickly evaporates, leaving a thin film of FORAL AX (or in another embodiment, FORAL DX, or another suitable substantially clear and colorless, water/perspiration proof, non-irritating and non-toxic thermoplastic, acidic hydrogenated wood and/or gum resin which may be heat and pressure activated) on the surface of the handle of the baseball bat or other article (the speed of evaporation depending on, for example, the local humidity and temperature). In this embodiment, the thin film of FORAL AX (or in the alternative embodiment, FORAL DX or other suitable resin) on the surface of the baseball bat or other article, presents the user with a substantially clear and colourless, water/perspiration proof, non-toxic, non-irritating, non-staining, heat and pressure activated tackifier. As one skilled in the art will appreciate, the isopropyl alcohol is effectively acting as a delivery vehicle, and other suitable delivery vehicles having the same/similar desirable properties (preferably substantially clear, colorless, non-irritating, evaporates quickly and leaves no toxic residue) may be used/substituted in place of isopropyl alcohol.

In a preferred embodiment, different formulations of the tackifier may be provided, depending upon the tackifier's intended usage. For example, in the context of providing a tackifier for use on baseball bats, in a preferred embodiment, a solution of 33% FORAL AX and 67% isopropyl alcohol (by weight) (or alternatively 33% FORAL DX and 67% isopropyl alcohol (by weight)) may be used, it being understood that the ratio of FORAL AX to isopropyl alcohol (or alternatively the ratio of FORAL DX to isopropyl alcohol) may be varied through a wide range of, for example, 5% FORAL AX:95% isopropyl alcohol (or alternatively 5% FORAL DX:95% isopropyl alcohol) to 33% FORAL AX: 67% isopropyl alcohol (or alternatively 33% FORAL DX:67% isopropyl alcohol). For example, in the context of providing a tackifier for use on golf club handles, in a preferred embodiment, a solution of 5% FORAL AX: 95% isopropyl alcohol (or alternatively 5% FORAL DX:95% isopropyl alcohol) may be used, it being understood that the proportion FORAL AX (or alternatively FORAL AX) to isopropyl alcohol may be varied through a wide range of, for example, 5% FORAL AX:95% isopropyl alcohol to 33% FORAL AX:67% isopropyl alcohol (or alternatively, 5% FORAL DX:95% isopropyl alcohol to 33% FORAL DX: 67% isopropyl alcohol). The FORAL AX isopropyl alcohol solution (and the FORAL DX isopropyl alcohol solution), at −26° C. becomes saturated with FORAL AX (FORAL DX) at a ratio of approximately 33% to 34% FORAL AX:66%-67% isopropyl alcohol (or 33% to 34% FORAL DX:66-67% isopropyl alcohol), with any relative increase in the amount of FORAL AX (or alternatively, FORAL DX) in the solution resulting in some of the FORAL AX (or alternatively, FORAL DX) becoming suspended or precipitating out of the solution, and not dissolved in the saturated FORAL AX isopropyl alcohol solution (or alternatively in the saturated FORAL DX isopropyl alcohol solution). While it is desirable to maintain a ratio of FORAL AX to isopropyl alcohol (or alternatively a ratio of FORAL DX to isopropyl alcohol) in which the FORAL AX (or alternatively, FORAL DX) remains fully dissolved in the FORAL AX isopropyl alcohol solution (or alternatively in the saturated FORAL DX isopropyl alcohol solution), throughout the solution's temperature range of −26° C. to 40° C., in one embodiment of the present invention, a solution is provided in which the ratio of the FORAL AX to isopropyl alcohol (or alternatively the ratio of the FORAL DX to isopropyl alcohol) exceeds the saturation limit of FORAL AX at −26° C. (or alternatively exceeds the saturation limit of FORAL DX at −26° C.), for example, when a solution will only be stored and used in a higher temperature range. This embodiment of the present invention may be useful in the context of higher than −26° C. applications of the solution, or where the solution is used in contexts where the substantially clear and colorless characteristics of the solution are of lesser importance to the user, and where a fully saturated tackifier solution having additional suspended FORAL AX (or alternatively FORAL DX) is desirable.

In an alternative embodiment, the tackifier solution of the present invention is in a solid or gel form at room temperature, and through the temperature ranges of −26° C. through 40° C., the resin having been dissolved in, for example, a material known to a person skilled in the art to provide a solid stick matrix.

The invention will now be explained by way of examples. However, the invention is not limited to the examples which are for illustrative purposes.

Seven different formulations of the composition were prepared and subjected to a 90° peel test and to a Z-direction test. The seven formulations were 35% FORAL AX (sample #1), 27.5% FORAL AX (sample #2), 20% FORAL AX (sample #3), 12.5% FORAL AX (sample #4), 5% FORAL AX (sample #5), 27.5% FORAL DX (sample #6) and 5% FORAL DX (sample #7).

### Peel Adhesion Test

Peel adhesion tests were performed on a ChemiInstruments AR-1000 adhesion release tester in conjunction with the EZ lab software program.

The 25 mm polyester film strips were coated with one of the formulations and allowed to air dry for 10 minutes at 23° C. at 50±5% relative humidity. The 25 mm prepared sample was applied to a standard stainless steel test panel at a rate of 24 in./min, with a 4½ pound rubber covered roller according to the method. The sample was then peeled from the substrate at a 90° angle after a dwell time of one minute. The force required for removal was measured, as shown in Table 1.

### Z-Direction Peel

Z-Direction peel was tested on a Tinius Olsen tensile tester. Specifically prepared T-blocks were fabricated with a 25 mm by 25 mm surface on one block and a 38 mm by 38 mm surface on the other. The formulations were sprayed on the smaller of the block faces in the same manner as described above. Once treated, the block face was allowed to air dry for 20 minutes. When dry, it was mated in the center to the larger T-block face.

The mated T-blocks were placed in the jaws of the tensile tester and the tester was operated in compression mode at a rate of 0.05 in./min. speed until a force of 10 pounds was reached. At that time motion was stopped and the force was held for 10 seconds. The tester was then operated in tension at a rate of 0.05 in./min. speed until the T-blocks separated. The maximum force required for separation was measured and is shown in Table 2.

It is of note that, as discussed above, the experiments were carried out at approximately 23° C. and at approximately 50% relative humidity. As will be appreciated by one of skill in the art, different values would be obtained at different temperatures and at different humidities.

Referring to Tables 1 and 2, it is of note that 35% FORAL AX (sample #1) and 27.5% FORAL AX (sample #2) provided very similar results in the 90° peel adhesion test but the 35% formulation produced results which were approximately 5% higher than the 27.5% formulation in the z-direction peel test. The 27.5% FORAL DX formulation (sample #6) produced values which were approximately 10-15% lower than the 27.5% FORAL AX formulation (sample #2) but approximately 50% higher than the 20% FORAL AX formulation (sample #3) in the 90° peel adhesion test. However, in the z-direction peel test, the 27.5% FORAL DX formulation and the 20% FORAL AX formulation produced very similar values. In the 90° peel adhesion test, the 5% FORAL DX formulation (sample #7) produced higher values compared to the 5% FORAL AX formulation (sample #5) but both samples produced similar values in the Z-direction peel test.

As can be seen from the above data, different concentrations of FORAL AX and FORAL DX produce tackifier compositions with somewhat different properties. For example, in some uses, it may be desirable to have greater 180° adhesion so that the gripped article remains in contact with the hand of the user but lesser 90° adhesion so that the article may be turned by the user, for example, in racquet sports where grips are frequently adjusted during play. In other uses, greater 90° adhesion and lesser 180° adhesion may be preferred so that the gripped article does not twist during use but can be released more easily. As is apparent, this is directly related to user preference and some users may prefer a specific formulation for a given use while others will find greater success or comfort with a somewhat higher or lower strength composition. In addition, as discussed above, different users may find that multiple applications of a metered amount of a given solution may provide more or less desirable results compared to a single metered application of a higher concentration solution. Similarly, users may prefer using a given concentration and/or given application method under certain conditions, for example, under lower or higher humidity and/or lower or higher temperature, but also under conditions of circumstance, for example, the stage or situation within a sporting contest.

7 g of Foral AX was added to 93 g of isopropanol under agitation at room temperature. The Foral was completely dissolved within five minutes, thereby providing a 7% Foral AX, 93% isopropanol solution.

A 50% Foral AX/50% isopropanol composition was prepared by dissolving Foral AX in isopropanol at 35° C. in a 500 mL flask fitted with a reflux condenser, thermocouple, and stirrer. The condenser was used to prevent the loss of isopropanol through vaporisation. Heat was provided by mounting the flask in a heating mantle. 125 g of isopropanol was charged to the flask and the stirrer was started at medium speed. The thermocouple septum was removed and 125 g of Foral AX was added through a funnel. The Foral resin had been ground to a rough powder by hammering between sheets of aluminum foil with a rubber mallet. A low flow of cold water was started through the condenser. The heat was turned on and the temperature adjusted to approximately 35-37° C. Stirring was maintained until the resin was completely dissolved, about 10 minutes. The heating mantle was removed and the solution allowed to cool to room temperature. After reaching room temperature, the solution was transferred to a sealed jar. The solution became cloudy as it cooled.

### Formula Example 1

5% Foral AX

95% Isopropanol

### Formula Example 2

7% Foral AX

93% Isopropanol

### Formula Example 3

20% Foral AX

80% Isopropanol

### Formula Example 4

20% Foral AX

80% anhydrous ethanol

### Formula Example 5

30% Foral AX

70% isopropanol

### Formula Example 6

30% Foral AX

70% anhydrous ethanol

### Formula Example 7

35% Foral AX

65% Isopropanol

### Formula Example 8

25% Foral AX

75% Anhydrous ethanol

### Formula Example 9

15% Foral AX

85% Isopropanol

### Formula Example 10

15% Foral AX

85% Anhydrous ethanol

While the preferred embodiments of the invention have been described above, it will be recognized and understood that various modifications may be made therein, and the appended claims are intended to cover all such modifications which may fall within the spirit and scope of the invention.

TABLE 1
90° Peel Adhesion (ASTM D 3330F)
on stainless steel (grams/25 mm width)

| Replicate | Sample 1 | Sample 2 | Sample 3 | Sample 4 |
|---|---|---|---|---|
| 1 | 69.7 | 67.5 | 41.8 | 13.9 |
| 2 | 75.5 | 70.7 | 34.4 | 16.9 |
| 3 | 79.8 | 82.7 | 39.8 | 18.3 |
| 4 | 65.0 | 75.8 | 47.1 | 16.9 |
| 5 | 76.5 | 69.2 | 39.4 | 19.9 |

| Replicate | Sample 5 | Sample 6 | Sample 7 |
|---|---|---|---|
| 1 | 0.6 | 55.7 | 1.7 |
| 2 | 0.7 | 63.9 | 1.3 |
| 3 | 1.2 | 59.9 | 1.8 |
| 4 | 0.8 | 74.9 | 1.7 |
| 5 | 0.9 | 64.7 | 1.2 |

TABLE 2
Z-direction peel (modified TAPPI T-541
method) on aluminum (pounds/in²)

| Replicate | Sample 1 | Sample 2 | Sample 3 | Sample 4 |
|---|---|---|---|---|
| 1 | 4.25 | 3.83 | 3.50 | 0.38 |
| 2 | 3.78 | 4.40 | 3.68 | 0.41 |
| 3 | 4.56 | 3.52 | 3.49 | 0.26 |
| 4 | 3.72 | 4.55 | 3.42 | 0.48 |
| 5 | 4.61 | 3.61 | 3.58 | 0.44 |

| Replicate | Sample 5 | Sample 6 | Sample 7 |
|---|---|---|---|
| 1 | 0.07 | 3.62 | 0.09 |
| 2 | 0.06 | 3.47 | 0.06 |
| 3 | 0.07 | 3.50 | 0.10 |
| 4 | 0.09 | 3.49 | 0.06 |
| 5 | 0.13 | 3.68 | 0.08 |

1. A tackifying composition for enhanced gripping contact comprising:
a non-toxic heat and pressure activated rosin dissolved in an evaporating solvent, wherein the rosin has a Gardner number of 1-4.

2. The tackifying composition according to claim 1 comprising
5-40% rosin; and
60-95% solvent.

3. The tackifying composition according to claim 2 wherein the rosin is Foral AX™ or Foral DX™.

4. The tackifying composition according to claim 3 wherein the solvent is
isopropanol or ethanol.

5. A tackifying composition for enhancing gripping contact consisting essentially of:
a non-toxic heat and pressure activated rosin dissolved in an evaporating solvent, wherein the rosin has a Gardner number of 1-4.

6. The tackifying composition according to claim 5 wherein the rosin is Foral AX™ or Foral DX™.

7. The tackifying composition according to claim 6 wherein the solvent is isopropanol or ethanol.

8. A method of improving or enhancing gripping contact of a surface comprising:
applying an effective amount of a tackifying composition comprising a non-toxic heat and pressure activated rosin having a Gardner number of 1-4 dissolved in an evaporating solvent to said surface.

9. The method according to claim 8 wherein the composition comprises:
5-40% rosin; and
60-95% solvent.

10. The method according to claim 9 wherein the rosin is Foral AX™ or Foral DX™.

11. The method according to claim 10 wherein the solvent is isopropanol or ethanol.

12. A method of improving grip on a grip-able surface comprising:
providing a tackifier solution having a Gardner number of 1-4 comprising a pale, highly hydrogenated, non-toxic rosin in a lower alcohol solvent;
applying an effective amount of the tackifier solution onto a non-skin grip-able surface; and
having a user grasp the grip-able surface, wherein the grip of the user on the grip-able surface is improved compared to a substantially similar, untreated grip-able surface.

13. The method according to claim 12 wherein the composition comprises:
5-40% rosin; and
60-95% solvent.

14. The method according to claim 13 wherein the rosin is Foral AX™ or Foral DX™

15. The method according to claim 14 wherein the solvent is isopropanol or ethanol.

16. A method of improving grip on a grip-able surface comprising:
providing a tackifier solution having a Gardner number of 1-4 comprising a pale, highly hydrogenated, non-toxic rosin in a lower alcohol solvent;
applying an effective amount of the tackifier solution onto a non-skin grip-able surface of an object or to at least one hand of a user; and
having the user grasp the grip-able surface, wherein the grip of the user on the grip-able surface is improved compared to a substantially similar, un-treated grip-able surface.

17. The method according to claim 16 wherein the composition comprises:
5-40% rosin; and
60-95% solvent.

18. The method according to claim 17 wherein the rosin is Foral AX™ or Foral DX™.

19. The method according to claim 18 wherein the solvent is isopropanol or ethanol.
